(19) United States
(12) Patent Application Publication
(10) Pub. No.: US 2023/0242396 A1
(43) Pub. Date: Aug. 3, 2023

(54) PREFERENTIAL OXIDATION OF CO IN H2-CONTAINING GAS

(71) Applicant: The Goverment of the United States of America, as represented by the Secretary of the Navy, Ariington, VA (US)

(72) Inventors: Travis G. Novak, Lorton, VA (US); Debra R. Rolison, Arlington, VA (US); Paul A. DeSario, Alexandria, VA (US)

(73) Assignee: The Government of the United States of America, as represented by the Secretary of the Navy, Arlington, VA (US)

(21) Appl. No.: 18/161,009

(22) Filed: Jan. 27, 2023

Related U.S. Application Data
(60) Provisional application No. 63/304,289, filed on Jan. 28, 2022.

(51) Int. Cl. C01B 3/16; B01J 23/72; B01J 23/10; B01J 35/00; B01J 12/00; B01J 19/24; B01J 19/00; H01M 8/0612

(52) U.S. Cl. CPC C01B 3/16; B01J 23/72; B01J 23/10; B01J 35/0013; B01J 35/0066; B01J 12/007; B01J 19/24; B01J 19/0013; H01M 8/0612; C01B 2203/0283; C01B 2203/1076; C01B 2203/1082; C01B 2203/066; H01M 2008/1095

(57) ABSTRACT

A method and apparatus for: providing a ceria aerogel and copper nanoparticle catalyst, flowing a hydrogen, carbon monoxide, and water vapor source gas from an inlet into contact with the catalyst to produce a product gas, and flowing the product gas to an outlet. The concentration of carbon monoxide in the product gas is no more than 50% of the concentration of carbon monoxide in the source gas. The concentration of hydrogen in the product gas is no less than 90% of the concentration of hydrogen in the source gas.

This application claims the benefit of U.S. Provisional Application No. 63/304,289, filed on Jan. 28, 2022. The provisional application and all other publications and patent documents referred to throughout this nonprovisional application are incorporated herein by reference.

### TECHNICAL FIELD

The present disclosure is generally related to carbon monoxide oxidation catalysts.

### DESCRIPTION OF RELATED ART

CO PReferential OXidation (often abbreviated COPROX, CO-PROX, or COPrOx) is a reaction that is particularly relevant to purifying hydrogen (H₂) feedstocks for use in industrial processes (ex. ammonia plants) or to power hydrogen fuel cells. Hydrogen feedstocks are commonly derived from processes that also yield smaller concentrations of CO as well as water vapor. As little as a few ppm of CO can easily poison the Pt-based anodes of proton-exchange membrane fuel cells (Valdés-López et al., Prog. Energy Combust. Sci. 79 (2020) 100842), making removal of CO through COPROX or methanation routes essential to performance and extended cell life. An effective COPROX catalyst must effectively oxidize one reducing gas (CO) without promoting any undesirable reactions in the easily oxidized other (H₂) (Bion et al., Top. Catal. 51 (2008) 76). The tendency of noble metals to readily react with H₂ makes them poorly suited to the task, even if economic and supply-risk concerns are ignored.

Catalysts based on Cu—CeO₂, in contrast, show significantly higher selectivity for oxidation of CO in the presence of excess H₂. In these systems, oxidation of CO proceeds through the Mars-van Krevelen mechanism, where interfacial site activate CO, which then extracts a lattice oxygen from the oxide support to form CO₂. Because the resulting oxygen vacancy must be healed to restart the catalytic cycle, the ease at which the supporting oxide cycles between oxidation states is a key factor in determining catalytic activity (Sun et al., Catal. Sci. Technol. 9 (2019) 2163-2172).

The valency (oxidation state) of Cu is another important point of optimization for these catalysts. Lower valent Cu (Cu¹⁺ or Cu⁰) exhibits greater activity than Cu²⁺ for CO oxidation, and these more active species are stabilized on reducing oxides such as TiO₂ and CeO₂. When the reducing oxide is expressed as an aerogel, a nanostructured mesoporous material, low-valent Cu persists even under oxidizing conditions (DeSario et al., Appl. Catal. B 252 (2019) 205-213; Pitman et al., Nanoscale Adv. 2 (2020) 21491-21501). Reduced Cu is also active for oxidation of H₂, but notable differences exist in the nature of these active sites that can be exploited to improve selectivity. Gamarra et al. observed that CO oxidation is favored specifically along Cu—CeO₂ interfacial sites, while H₂ oxidation takes place on Cu not directly in contact with the support (Gamarra et al, J. Am. Chem. Soc. 129 (2007) 12064-12065).

Nanostructures of Cu—CeO₂ tailored for COPROX are reported in the scientific literature, and while some of these successfully achieve preferential oxidation of CO in their feedstreams, there is a notable gap between the as-tested conditions and real-world requirements. Often, Cu—CeO₂ COPROX catalysts are exclusively tested under dry conditions (Han et al., J. Mol. Catal. A: Chem. 335 (2011) 82-88; Gómez-Cuaspud et al., Int. J. of Hydrog. Energy 38 (2013) 7458-7468; Marińo et al., Int. J. of Hydrog. Energy 33 (2008) 1345-1353; Jung et al., Appl. Catal. B 2008, 84, 426-432; Gamarra et al., J. Power Sources 169 (2007) 110-116; Davó-Quiñonero et al., ACS Catal. 6 (2016) 1723-1731) that do not predict functionality in the humidified conditions of fuel-cell anodes (Ozen et al., Renew. Sustain. Energy Rev. 59 (2016) 1298-1306). Avgouropoulos et al. found CO conversion dropped dramatically for CuO—CeO₂ in the presence of water, with <50% CO converted at 150° C. and selectivity of less than 90% (Avgouropoulos et al., Chem. Eng. J. 124 (2006) 41-45). Similarly, Li et al. found that among CuO—CeO₂ catalysts doped with various transition metals, the temperature required to convert 50% of CO (T₅₀) increased by an average of 30° C. upon humidification of the feedstream (Li et al., Appl. Catal. B 108-109 (2011) 72-80).

The exact mechanism behind Cu—CeO₂ catalyst poisoning is debated, but under humid conditions, it is widely suspected to be transport-related. The formation of Cu⁺-carbonyls is the rate-limiting step in CO oxidation, and adsorbed molecular water blocks access of reactant molecules to carbonyl-forming CuOx interfacial sites (Gamarra et al., J. Catal. 263 (2009) 189-195). Hydroxyl depletion may be another contributing factor as the relative abundance of hydroxyls dictate whether CO oxidation proceeds through the more favorable bicarbonate intermediate or the less favorable carbonate intermediate. Abundant hydroxyls promote the formation of bicarbonates in preference to carbonates, and the former intermediate benefits CO oxidation (Davó-Quiñonero et al., ACS Catal. 6 (2016) 1723-1731).

### BRIEF SUMMARY

Disclosed herein is a method comprising: providing a catalyst comprising a ceria aerogel and copper nanoparticles; flowing a source gas comprising hydrogen, carbon monoxide, and water vapor from an inlet into contact with the catalyst to produce a product gas; and flowing the product gas to an outlet. The concentration of carbon monoxide in the product gas is no more than 50% of the concentration of carbon monoxide in the source gas. The concentration of hydrogen in the product gas is no less than 90% of the concentration of hydrogen in the source gas.

Also disclosed herein is an apparatus comprising: a catalyst chamber, a catalyst within the catalyst chamber, an inlet for flowing a source gas in contact with the catalyst, and an outlet for flowing a product gas from the catalyst chamber. The catalyst comprises a ceria aerogel and copper nanoparticles. The source gas comprises hydrogen, carbon monoxide, and water vapor.

### BRIEF DESCRIPTION OF THE DRAWINGS

A more complete appreciation will be readily obtained by reference to the following Description of the Example Embodiments and the accompanying drawings.

FIG. 1 schematically illustrates CeO₂ aerogel synthesis and photodeposition of Cu nanoparticles to create Cu/CeO₂ aerogels (PPO=propylene oxide).

FIG. 2 shows nitrogen isotherms used to calculate surface area.

FIG. 3 shows cumulative pore-volume as a function of pore diameter.

FIG. 4 shows CO and CO₂ concentration as a function of temperature.

FIGS. 5-7 show CO oxidation and hydrogen consumption for Cu/CeO₂ and Cu/GCO under FIG. 8 schematically illustrates the covalently networked aerogel nano architecture with well dispersed Cu NPs in intimate contact with the supporting oxide.

FIG. 9 shows XRD patterns of CeO₂ (lower curve) and GCO (upper curve) aerogels with inset showing FWHM of the CeO₂ (111) peak.

FIG. 10 shows particle size distributions calculated from TEM data (GCO: higher peaks ≤6.5, CeO₂ higher peaks ≥7).

FIG. 11 shows BJH pore size distributions with inset N₂ isotherms and calculated BET surface area indicated.

FIG. 12 shows a scanning electron micrograph of CeO₂ aerogel.

FIG. 13 shows transmission electron micrographs of CeO₂ aerogel. Fast Fourier Transforms of the micrograph (inset enlarged on right) show clear polycrystallinity. Lattice parameters for the CeO₂ (111) plane are indicated.

FIG. 14 shows a scanning electron micrograph GCO aerogel.

FIG. 15 shows transmission electron micrographs of GCO aerogel. Fast Fourier Transforms of the micrograph (inset enlarged on right) show clear polycrystallinity. Lattice parameters for the CeO₂ (111) plane are indicated.

FIG. 16 shows the X ray photoelectron spectra of the O1s region for CeO₂ and GCO aerogels before and after photodeposition of Cu nanoparticles.

FIG. 17 shows the X ray photoelectron spectra of the Ce3d region for CeO₂ and GCO aerogels before and after photodeposition of Cu nanoparticles.

FIG. 18 shows the X ray photoelectron spectra of the Cu2p region for CeO₂ and GCO aerogels before and after photodeposition of Cu nanoparticles.

FIG. 19 shows catalytic performance as a function of temperature of 5 wt. % Cu/CeO₂ (left curve) and Cu/GCO (right curve) aerogels under CO and O₂ with no other reactants.

FIG. 20 shows catalytic performance as a function of temperature of 5 wt. % Cu/CeO₂ (left curve) and Cu/GCO (right curve) aerogels under CO and O₂ with H₂ added. Open symbols and dashed lines correspond to O₂ selectivity as a function of temperature.

FIG. 21 shows catalytic performance as a function of temperature of 5 wt. % Cu/CeO₂ (right curve) and Cu/GCO (left curve) aerogels under CO and O₂ with H₂ and H₂O added. Open symbols and dashed lines correspond to O₂ selectivity as a function of temperature.

FIG. 22 shows catalytic stability of Cu/CeO₂ and Cu/GCO aerogels evaluated over a 16 h period 100° C.

FIG. 23 shows X-ray photoelectron spectra of the Cu2p region after catalytic testing of Cu/CeO₂ aerogel.

FIG. 24 shows X-ray photoelectron spectra of the Cu2p region after catalytic testing of Cu/GCO aerogel.

FIG. 25 shows X-ray photoelectron spectra of the Cu2p region after catalytic testing of Cu/CeO.

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

Disclosed herein is a catalytic material that selectively oxidizes carbon monoxide (CO) at low temperature in a feedstream comprising excess hydrogen (H₂) and retains its selectivity and activity even in the presence of water vapor. Selective CO oxidation in excess H₂, a reaction colloquially referred to as COPROX, is an important process for preferential removal of CO from hydrogen feedstocks. Existing COPROX catalysts typically suffer from incomplete CO oxidation and/or poor selectively towards CO, i.e., oxidizing the desired H₂ along with the target CO. These materials are also prone to deactivation in the presence of water vapor, a common constituent in H₂ feedstocks. Disclosed herein is the use of low-valent copper nanoparticles (Cu NPs) supported on a covalently networked ceria (CeO₂) aerogel to facilitate complete oxidization of CO at low temperature while leaving gaseous H₂ largely unaffected. Catalytic activity and stability persist even in the presence of water vapor. The CeO₂ support stabilizes the active Cu species against oxidation, maximizes interfacial contact with the NPs, and supplies lattice oxygen to drive CO oxidation.

Based on the current understanding of both CO oxidation in general and the specific considerations of COPROX catalysts, the following criteria were used for designing highly active and stable catalysts:
Excellent dispersion of Cu on or within the CeO₂ to promote the maximum number of active interfacial sites and increase the amount of low-valent Cu
Effective transport of water through the catalysts to mitigate blocking of active sites by adsorbed molecular water
A hydroxyl-rich surface to promote formation of bicarbonates over carbonates

FIG. 1 illustrates the steps involved in the synthesis of copper nanoparticles (Cu NPs) supported on nanoscale ceria (Cu/CeO₂) aerogels. CeO₂ aerogels are prepared using a sol-gel method followed by supercritical drying of the wet gel (Laberty-Robert et al., Chem. Mater. 18 (2006) 50-58). This method preserves the co-continuity of the pore-solid networks of the covalently networked, ultraporous oxide because supercritical extraction prevents surface tension (and thus compressive forces) being imposed in the wet gel as fluid is removed. Preventing collapse of the pores during drying of the wet gel is essential to the transport of both reactants and water molecules into the interior of the high surface-area oxide while the covalently bonded CeO₂ nanoparticles that define the framework of the architected oxide minimize sintering and particulate agglomeration. After supercritical drying, the aerogel is calcined in air to crystallize CeO₂ domains and improve the mechanical properties. The calcined aerogel is then dispersed into an alkaline solution and mixed with copper (II) nitrate in an ethanol/water mixture under broadband irradiation to photodeposit Cu NPs onto the aerogel surface (DeSario et al., Nanoscale 9 (2017) 11720-11729). The solution is then vacuum filtered over a membrane or centrifuged gently to recover the aerogel from solution and the recovered solid is dried at low temperature (<100° C.) overnight to remove residual water.

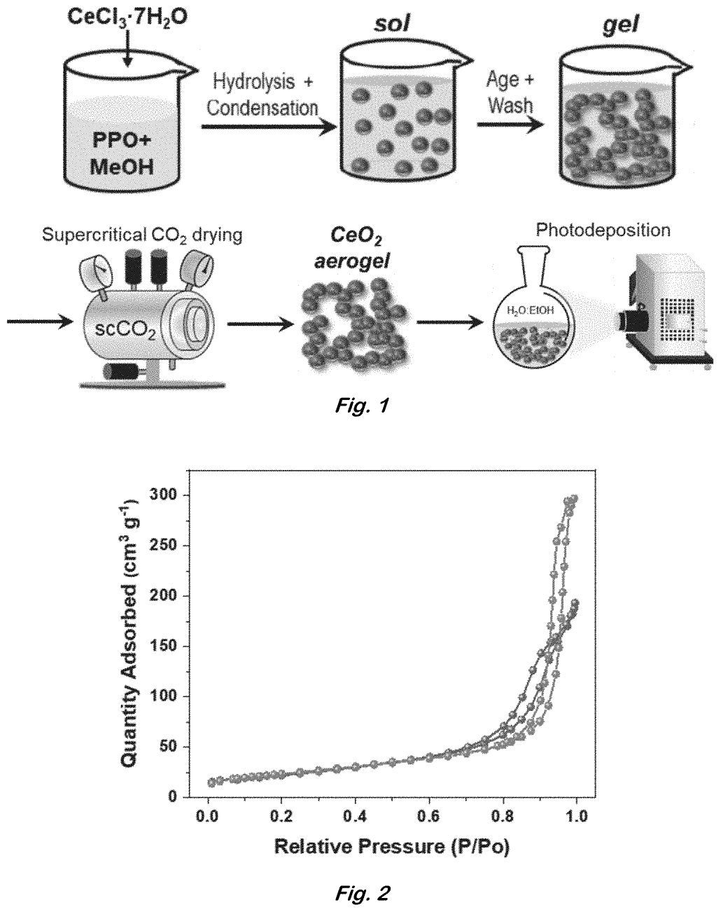

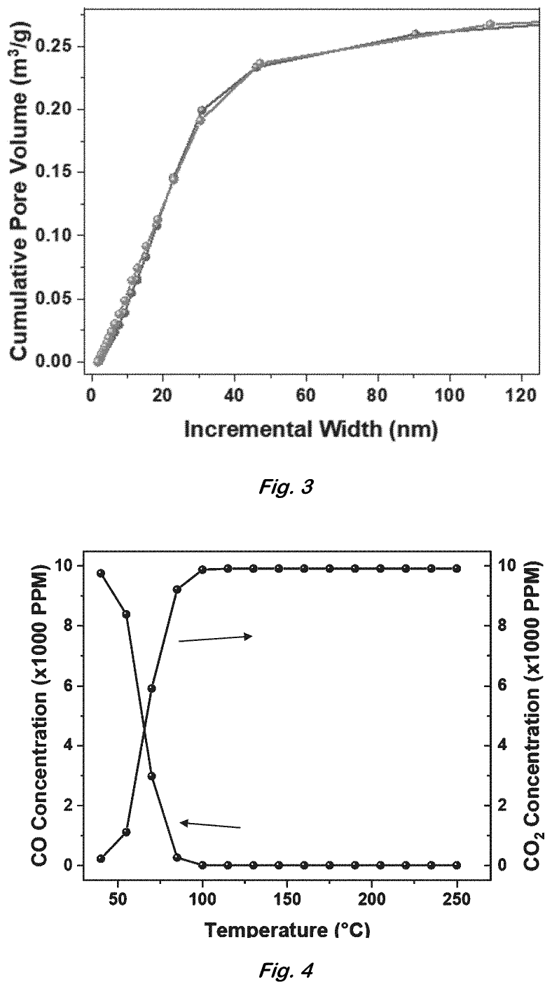

Structural characterization reveals that the underlying architecture of the aerogel is maintained after immersion into the water/ethanol suspension used to photodeposit Cu NPs. X-ray diffraction (XRD) patterns of CeO₂ and 5 weight percentage of photodeposited Cu NPs on calcined ceria aerogel (5Cu/CeO₂), have peaks corresponding to the fluorite crystal structure CeO₂ in both materials. Peaks for potential Cu-phases, such as metallic Cu, Cu₂O, or CuO, do not appear in 5Cu/CeO₂, indicating small particle size and/or amorphous regions. Nitrogen isotherms (FIG. 2) and pore-volume distribution plots (FIG. 3) confirm the structural preservation, where the calculated BET surface area is 79 and 83 m² g⁻¹ for CeO₂ and 5Cu/CeO₂ aerogels, respectively.

X-ray photoelectron spectroscopy (XPS) was used to evaluate the chemical states of the materials. Cerium in both CeO₂ and Cu/CeO₂ appears as primarily Ce⁴⁻, an expected result as the calcination in air tends to heal most oxygen vacancies. In the O1s region, two peaks are designated: Oₐ and O_{b}. Oₐ is stoichiometric (lattice) oxygen in CeO₂, (Sohn et al., Catal. Lett. 147 (2017) 2863-2876) while O_{b} contains overlapping contributions from oxygen vacancies in CeO₂ (Sohn) (i.e., O in Ce₂O₃) as well as hydroxyl groups on either the oxide or the Cu surface (Liu et al., Phys. Chem. Chem. Phys. 18 (2016) 16621-16628). The higher intensity of the O_{b} peak in Cu/CeO₂ compared to CeO₂ is likely a product of Cu activating water at the interfaces to form hydroxyl groups, similar to that reported for Cu NPs photodeposited on TiO₂ aerogel (McEntee et al., ACS Appl. Nano Mater. B (2020) 3503-3512).

XPS of the Cu2p region confirms that Cu exists entirely in a low-valent state (Cu¹⁺ or metallic Cu). Satellite peaks that appear prominently in CuO are not detected. This high proportion of low-valent Cu is facilitated by intimate contact between Cu nanoparticles and the reducing oxide support (Pitman et al., Nanoscale Adv. 2020, 2, 4547-4556; Laberty-Robert et al., Adv. Mater. 2007, 19, 1734-1739).

A typical COPROX reaction was conducted in a packed bed reactor in a programmable ceramic tube oven, where 50 mg of the catalyst was diluted with 200 mg of CeO₂ aerogel to increase space time. Prior to measurements, the sample was pretreated in a reducing atmosphere (CO without O₂) during the 1-hour ramp from room temperature to 250° C. During the experiment, the total flow of gases was held constant at 80 mL min⁻¹ with 20% O₂ and 1% CO (He balance). Products were analyzed using an in-line GC (GC-2014, Shimadzu) as the temperature was decreased in increments of 15° C., with 5 injections at each temperature point to ensure there were no residuals in the column.

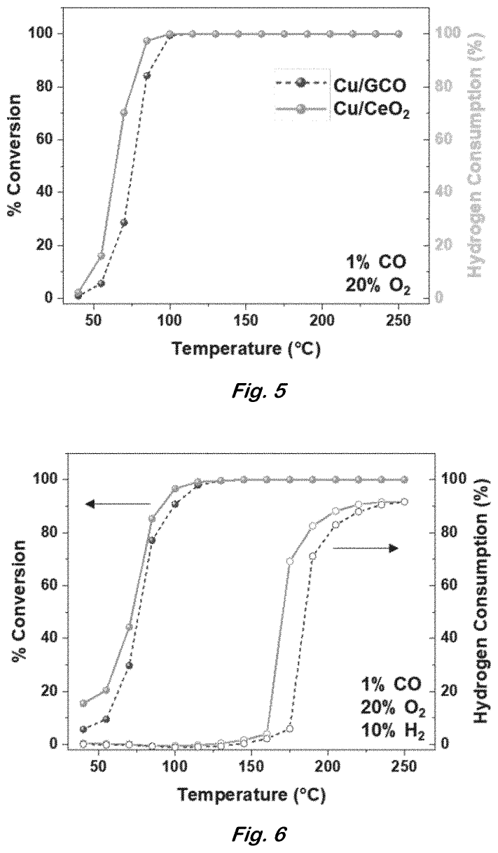

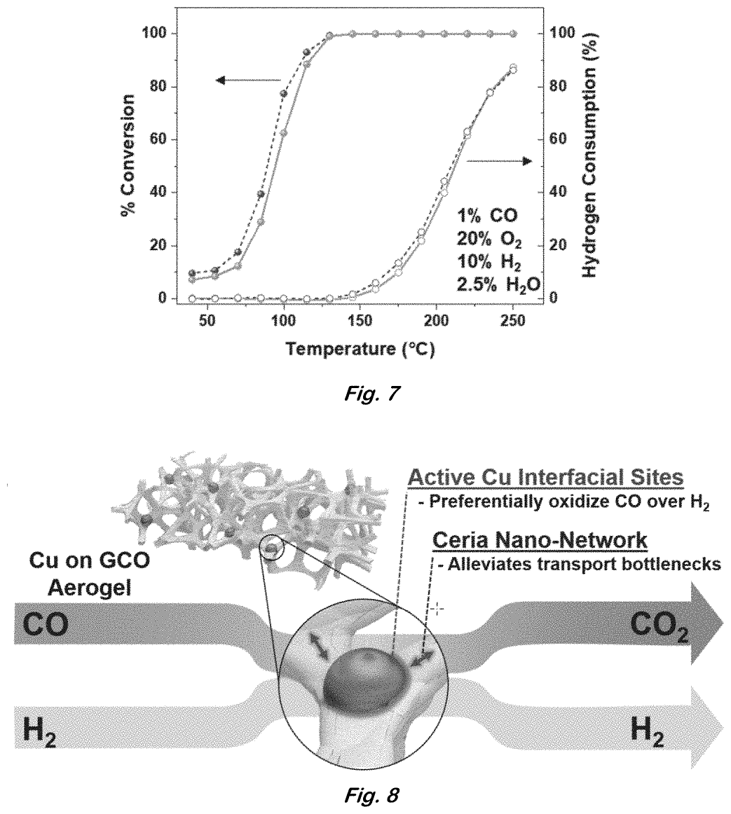

As shown in FIG. 4, the generated concentration of CO₂ mirrors CO consumption, and no other products are detected. FIGS. 5-7 show the CO oxidation performance and stability of Cu/CeO₂ under various conditions. Without H₂ or H₂O added, the temperature to achieve 50% CO conversion (T₅₀) is only 65° C., shifting to 71° C. with the addition of H₂, and 95° C. with both H₂ and H₂O. Despite the high activity towards CO oxidation, no consumption of H₂ above the error range for this peak (˜500 ppm) was observed until 145° C. In terms of O₂ consumption, this indicates that selectively towards CO is ≥95.3% at temperatures of 130° C. and below. Previously reported CeO₂-based materials are unable to achieve this combination of >90% selectivity and >90% CO conversion under humid conditions (Avgouropoulos et al., Chem. Eng. J. 2006, 124, 41-45; Han et al., Appl. Catal. B 108-109 (2011) 72-80; Park et al., J. Power Sources 132 (2004) 18-28).

Cu/CeO₂ aerogels doped with 10 mol % gadolinium (Gd) were also evaluated for the COPROX reaction. Compared to CeO₂ aerogels, Gd-doped CeO₂ (GCO) aerogels have a higher proportion of Ce³⁺ states and higher surface area (146 m² g⁻¹). Cu/GCO aerogels are slightly less active than Cu/CeO₂ under dry CO oxidation conditions, perhaps due to fewer Ce⁴⁺ sites available for 3+/4+ redox cycling, but do not suffer as much loss in activity when exposed to water. Upon addition of H₂ and H₂O to the feedstream, the T₅₀ for Cu/GCO shifts only 15° C. compared to 30° C. for Cu/CeO₂. The improved selectivity for Cu/GCO is further evidence that CO oxidation with H₂O in the feedstream is a transport-limited reaction: the higher surface area of Cu/GCO and its higher number density of chemically fixed oxygen vacancies enable the substituted ceria aerogel to more effectively distribute water as well as react with it to hydroxylate the surface, both of which mitigate blockage of active sites.

The long-term stability of transition metal-based COPROX catalysts under humid conditions is rarely reported, and the few published results that exist suggest it is problematic. Notably, Gongalves et al. observed that Cu nanoparticles were stable under dry feedstreams for CO oxidation, but experienced continuous deactivation when exposed to 1% water vapor (Gongalves et al., ACS Appl. Mater. Interfaces 2015, 7, 7987-7994). Other transition metals used in conjunction with ceria, such as Mn and Co, are also known to generally be unstable under humid conditions (Basu et al., ChemCatChem 2020, 12, 3753-3768). One report that processed a Cu—CeO₂ catalyst using freeze-drying, also experienced deactivation in the presence of H₂O (g) (Arango-Diaz et al., Appl. Catal. A 477 (2014) 54-63).

To test the long-term catalytic stability of Cu/CeO₂, the CO oxidation activity and selectively was monitored for 16 hours. The hold temperatures are selected to ensure significant CO oxidation activity, but less than 100% conversion to ensure that potential changes in activity are quantifiable. Under all tested conditions, no significant change in activity or selectivity is observed. Deactivation of COPROX catalysts under humid conditions is often regarded as a transport issue, with accumulated water blocking active sites. The bonded oxide network in manganese oxide (Doescher et al., Anal. Chem., 77 (2005) 7924-7932) and titanium oxide aerogels prevents flooding of the mesopores until reaching tropical levels of humidity (>80%) because the water adsorbed at the oxide network is distributed along that network and serves as a transport wire for proton diffusion. The expression of CeO₂ and substituted ceria in aerogel form provides the through-connected mesoporosity to effectively mitigate these transport limitations and more effectively shuttle adsorbed species away from these sites.

In a first step, a ceria aerogel/copper nanoparticle catalyst, such as that described above, is provided. The catalyst may comprise, for example up to 1, 2, 3, 4, 5, 6, 7, 8, 9, or 10 wt. % of the copper nanoparticles. Further, the ceria may be doped with up to 1, 2, 3, 4, 5, 6, 7, 8, 9, 10, 15, or 20 mol % gadolinium. The catalyst is disposed in a catalyst chamber.

Next, a source gas comprising hydrogen, carbon monoxide, and water vapor flows from an inlet, into the chamber, and in contact with the catalyst. Optionally, the catalyst is heated to an elevated temperature by a heater. The catalyst alters the composition of the source gas to make a product gas. The elevated temperature may be no more than 200, 180, 160, 145, 130, 115, or 100° C.

Next, the product gas flows out of the chamber through an outlet. The outlet may direct the product gas into further apparatus, such as a hydrogen storage vessel or a fuel cell reaction chamber.

Due to the catalyst, the concentration of carbon monoxide in the product gas is no more than 50%, 40%, 30%, 20%, or 10% of the concentration of carbon monoxide in the source gas. Also, the concentration of hydrogen in the product gas is no less than 90% or 95% of the concentration of hydrogen in the source gas. The concentrations can be measured by methods known in the art. When the catalyst is heated, the concentration measured may be used to determine a suitable temperature.

By redesigning the arrangement of Cu NPs with reducing oxide NPs by imposing an aerogel morphology, the degree of intimacy at the Cu//oxide interface is markedly enhanced, allowing preferential oxidation of CO in a H₂-rich feedstream. The intimacy of the Cu//oxide junction enabled by an architected catalyst may accrue the following technological advantages: (1) high activity for CO oxidation at modest temperature (T<100° C.); (2) selective CO oxidation in the presence of H₂ at T<100° C.; and (3) selective and stable CO oxidation in the presence of H₂ and H₂O at T<100° C.

The performance of these catalysts under practical feedstreams enables refinement of hydrogen feedstocks to the purity levels needed for such applications as PEMFCs. Architected catalysts as a design metaphor should also provide effective activity, selectivity, and durability for other catalytic oxidations compromised by the presence of water.

The following examples are given to illustrate specific applications. These specific examples are not intended to limit the scope of the disclosure in this application.

Synthesis of CeO₂ aerogels—CeO₂ and GCO aerogels were prepared using a modification of previous methods (Pitman et al., Nanoscale Adv. 2020, 2, 4547-4556; Laberty-Robert et al., Adv. Mater. 2007, 19, 1734-1739). First, 2.39 g of CeCl₃·7H₂O (Sigma-Aldrich, 99.9%) was dissolved in 10 g of anhydrous methanol (Fisher, 99.9%), followed by adding 6 g of propylene oxide (Sigma-Aldrich, ≥99%) [Safety Note: this epoxide is carcinogenic]. In the case of GCO, 10 mol % of GdCl₃·6H₂O was substituted for 10 mol % CeCl₃·7H₂O to form a Gd_{0.1}Ce_{0.9}Oₓ sol; Gd_{0.05}Ce_{0.95}Oₓ was also prepared by substituting 5 mol % GdCl₃·6H₂O. The mixture was stirred for 20 min and left to gel overnight. The wet, aged gels were rinsed several times with isopropanol followed by acetone and then loaded into a Leica EM CPD300 autoclaved and programmed for 99 CO₂ flushes. After supercritical drying at 42° C., the autoclave was gradually vented to atmospheric pressure. The aerogels were calcined in air at 500° C. (5° C. min-1 ramp, 2 h dwell) to crystallize the networked CeO₂ nanoparticles (NPs).

Photodeposition of Cu nanoparticles—Copper NPs were photodeposited as previously described (Pitman et al., Nanoscale Adv. 2020, 2, 4547-4556; DeSario et al., Nanoscale 2017, 9, 11720-11729) using ceria aerogel ground through a 45 m sieve. For 5 wt. % Cu/CeO₂, 38 mg of Cu(NO₃)₂·2.5H₂O was dissolved in 200 mL of 10 vol. % ethanol in water into which 200 mg of CeO₂ aerogel was dispersed. An equivalent 200 mg of GCO aerogel or commercial CeO₂ powder (Aldrich, <50 nm particle size) was used for preparation of Cu/GCO aerogel and Cu/CeO₂—COM. Aqueous NaOH was added to adjust the suspension pH to 9.5±0.1; the initial adjustment is made with 1 M NaOH with a final adjustment using 0.1 M NaOH. The pH-adjusted suspension was then purged with N₂ before irradiating for 48 h using a 500 W Xe arc lamp (Newport-Oriel). The blue-green solids were collected by vacuum filtration over a 0.1 m PVDF filter, rinsed with 18 MQ cm water, and dried overnight under ambient conditions.

Characterization—Brunauer-Emmett-Teller (BET) surface area and Barrett-Joyner-Halenda (BJH) pore size distributions were calculated using the adsorption and desorption curves, respectively, of the N₂ physisorption isotherms (Micromeritics ASAP2020). Samples were degassed under vacuum at 150° C. prior to N₂ physisorption. X-ray diffraction (XRD) data were collected using a Rigaku Smartlab (40 kV, 44 mA) at a 4° min⁻¹ scan speed. X-ray photoelectron spectra were taken using a Thermo Scientific Nexsa (Al Kα) and a flood gun to prevent charging. X-ray absorption near-edge spectroscopy (XANES) measurements were executed using an in-lab X-ray absorption spectrometer (easyXAFS300) with a 1.2 kW liquid-cooled X-ray tube operating at 30 kV and 12 mA. The spectrometer was configured with a Si (440) spherically bent crystal analyzer to investigate the Ce L3 absorption edge. Three consecutive scans were averaged for each material to improve the signal-to-noise ratio. Raman spectra were collected on a Renishaw inVia Raman microscope with a 514 nm laser source and imaged through a 50× objective. Micrographic imaging was performed on a LEO Supra 55 field-emission scanning electron microscope operating at 10 kV. Samples analyzed by transmission electron microscopy (TEM) were sonicated and drop-cast onto conductive “lacey” carbon. High-resolution TEM (HRTEM) and high-angle annular dark-field (HAADF) images and EDS maps were obtained using a JEOL JEM2200FS TEM operating at 200 kV with 0.7 nm nominal probe size.

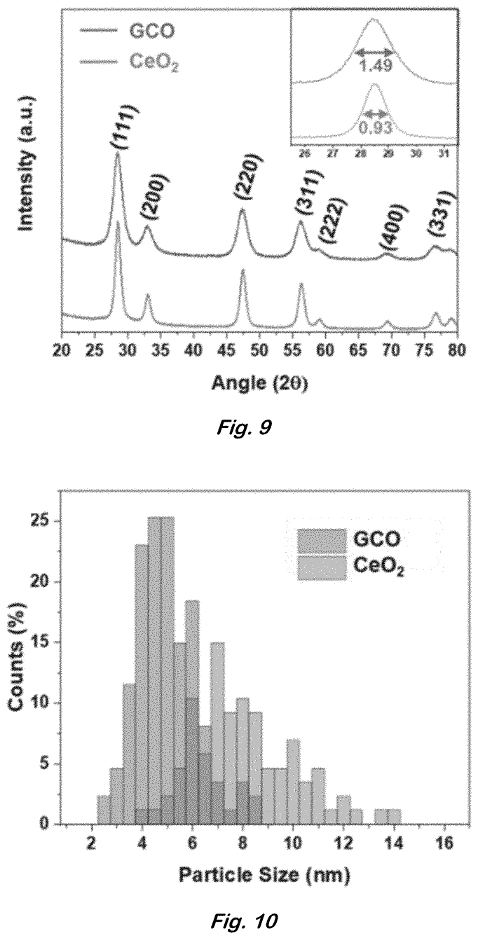

FIG. 8 illustrates the networked Cu/aerogel structure for the COPROX reaction. Both the CeO₂ and GCO aerogels are mesoporous structures comprising covalently networked nanocrystalline oxide domains. The X-ray diffraction patterns of calcined CeO₂ and GCO are consistent with the fluorite crystal structure (FIG. 9), but the GCO diffraction peaks are broader relative to CeO₂ (FIG. 8, inset), revealing smaller primary crystallite diameters for GCO. Crystallite sizes based on the Scherrer equation are ˜9 and ˜6 nm for CeO₂ and GCO, respectively. Diffraction peaks for Gd₂O₃ are absent, indicating that Gd(III) substitutes into the CeO₂ lattice rather than phase segregating. Particle size distributions derived from TEM analysis (FIG. 10) confirm the smaller average particle sizes in calcined GCO (4-5 nm) compared to CeO₂ (7-8 nm), in agreement with the broadened XRD peaks for GCO.

The porosimetry-derived Barrett-Joyner-Halenda (BJH) pore size distributions (FIG. 11) and Brunauer-Emmett-Teller (BET) surface-areas (FIG. 11, inset) reveal that GCO has a smaller average pore size and higher surface area than CeO₂. The CeO₂ and GCO aerogels with either 5 or 10 mol % Gd have essentially identical surface area prior to calcination (˜300 m² g⁻¹) and more of this surface area is retained post-calcination as the Gd mol % increases, consistent with suppressing crystallite growth upon substituting Gd(III) for Ce(IV) (Inaba H et al., Solid State Ionics 1998, 106, 263-268; Durgasri et al., J. Chem. Sci. 2014, 126, 429-435). The peak broadening in XRD for GCO and the corroborating shift to smaller particle size distributions measured by TEM confirm that the higher surface area of GCO is related to the presence of finer crystallites.

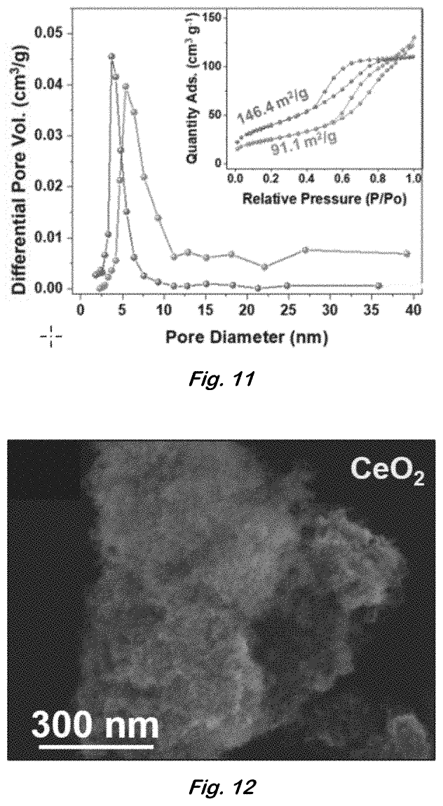

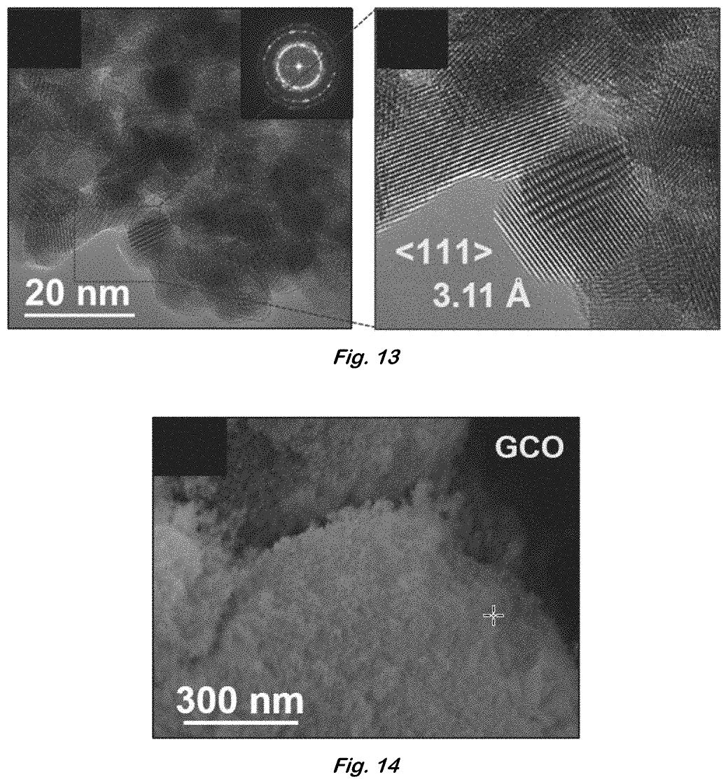

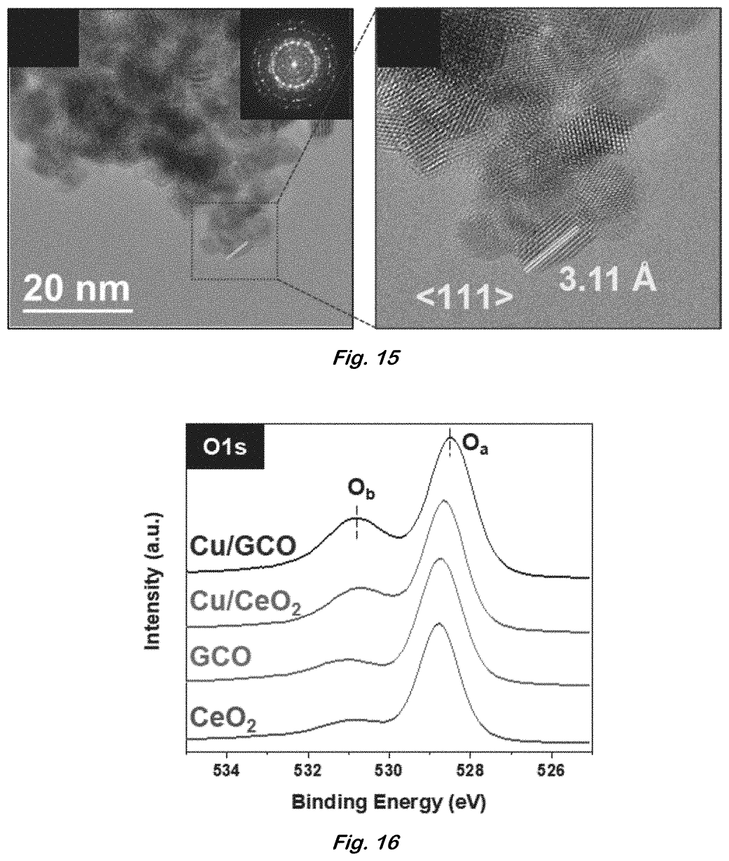

Scanning electron microscopy (SEM) confirms the mesoporous nature of both CeO₂ and GCO aerogels (FIGS. 12, 14) while the transmission electron micrographs reveal that the networked oxide NPs comprising both aerogel compositions are crystalline (FIG. 13 (left), 14 (left)), with a measured lattice parameter of 3.11 Å corresponding to the (111) plane of CeO₂ (FIG. 13 (right), 14 (right)). Gadolinium appears atomically dispersed in EDS mapping and the measured Gd content (8 at. %) closely matches the synthetically targeted value of 10 at. %.

X-ray photoelectron spectroscopy (XPS) and X-ray absorption near-edge structure (XANES) were used to monitor the chemical states of the CeO₂ and GCO aerogels before and after Cu photodeposition. The presence of Gd in GCO aerogels is confirmed by the prominent shoulder at −9 eV in valence-band XPS, as well as the appearance of peaks in the Gd₄d region at binding energies characteristic of Gd³⁺ (˜140.5 eV) (Zatsepin et al., Appl. Surf Sci. 2018, 436, 697-707). XANES of the cerium L3 edge reveals the corollary change in average Ce valance with Gd substitution, from 9% Ce³⁺ in CeO₂ to 11% in GCO.

The lower binding energy peak (˜528.5 eV) in the XPS O1s spectra (FIG. 16, designated Oₐ) is primarily assigned to lattice oxygen in stoichiometric CeO₂ (Liang et al., J. Mater. Chem. A 2015, 3, 634-640; Sohn et al., Catal. Lett. 2017, 147, 2863-2876), although some contribution from O in CuO is also possible (Zheng et al., J. Mater. Sci. 2016, 51, 917-925). The higher binding energy peak at ˜531 eV (O_{b}) is a combination of contributions from oxygen-deficient ceria (i.e., G in Ce₂O₃) (Sohn) or surface hydroxyl groups (Liu et al., PhysChemChemPhys 2016, 18, 16621-16628) on Cu or CeO₂. A more prominent O_{b} peak is seen for GCO, an expected result because of the oxygen vacancies created to charge compensate Gd³⁺ substitution into Ce⁴⁺ lattice sites. Raman spectroscopy also indicates the presence of Gd-induced oxygen vacancies through the emergence of α and β peaks not seen in pristine CeO₂ (Durgasri et al., J. Chem. Sci. 2014, 126, 429-435).

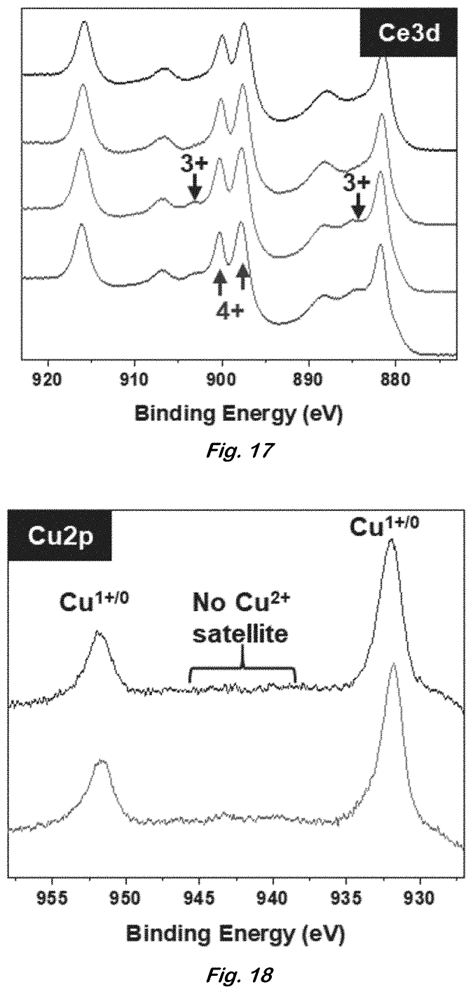

The photoelectron intensity of the O_{b} peak increases after Cu photodeposition for both CeO₂ and GCO aerogels; this peak was previously assigned to an increased density of surface hydroxyl groups (McEntee et al., ACS Appl. Nano Mater. 2020, 3, 3503-3512). Although some Ce³¹ is discernable (FIG. 17), the binding energy of Ce3d peaks are predominately Ce⁴⁺. For both CeO₂ and GCO, the weak Ce³⁺ peaks decrease in intensity after Cu photodeposition, likely because the photodeposited metal nucleates at oxygen vacancies (Pitman et al., Nanoscale Adv. 2020, 2, 4547-4556).

The Cu2p region reveals that Cu is present entirely in its low-valent speciation (metallic Cu or Cu¹⁺) when supported on either CeO₂ or GCO aerogels, with the characteristic Cu²⁺ satellite feature completely absent in spectra (FIG. 18). Intimate contact between the Cu NP nestled on the reducing oxide nanoparticulate network helps to stabilize low-valent Cu (Pitman et al., Nanoscale Adv. 2020, 2, 4547-4556), which stands in contrast to the primarily CuO speciation of most Cu/CeO₂ catalysts reported in COPROX studies (Tiscornia et al., Int. J. Hydrogen Energy 2020, 45, 6636-6650; Tiscornia et al., Catal. Today 2021, 10.1016/j.cattod.2021.08.008; Gómez-Cuaspud et al., Int. J. Hydrogen Energy 2013, 38, 7458-7468; Mariño et al., Int. J. Hydrogen Energy 2008, 33, 1345-1353; Jung et al., Appl. Catal. B 2008, 84, 426-432). No distinct Cu phases (metallic Cu, Cu₂O, or CuO) are detected in the XRD patterns of Cu/CeO₂ or Cu/GCO, indicating that the particles are small and well dispersed and/or amorphous. Imaging by TEM could not resolve individual Cu NPs, but EDS mapping reveals Cu to be uniformly distributed on both Cu/CeO₂ and Cu/GCO.

Catalyst testing—Oxidation of CO was performed in a ⅜″ glass tube flow-through reactor in a programmable ceramic tube furnace, with conditions chosen to minimize heat/mass transport effects and facilitate comparison to other published studies on CO oxidation (DeSario et al., Appl. Catal. B 2019. 252, 205-213; Pitman et al., Nanoscale Adv. 2020, 2, 4547-4556; Pennington et al., ACS Catal. 2020, 10, 14834-14846; Wu et al., Mater. Chem. Front. 2017, 1, 1754-1763). A packed bed comprising 50 mg of catalyst diluted with 200 mg of native CeO₂ aerogel was sandwiched between glass wool and conditioned during the 1 h ramp from RT to 250° C. under a continuous flow of 80 mL min⁻¹ of 1.75% CO (Airgas, 10000 ppm) and 98.25% He (Praxair, 5.0 UHP), giving a gas hourly space velocity (GHSV) of 39000 h⁻¹. The downstream gas mixtures were analyzed with an in-line gas chromatograph (GC-2014, Shimadzu) equipped with a pulsed discharge detector for product analysis. The GC detector was calibrated with known concentrations of CO and CO₂ in UHP He to ensure accurate quantitative analysis of CO conversion percentage and CO₂ yield. Temperature was decreased in 15° C. steps at 3° C. min⁻¹ and four replicate injections were performed at each set point. Additional reactions were performed with 10% H₂ added (He balanced to maintain a flow rate of 80 mL min-), and in a humidified stream using the same gas composition as the dry runs, but the mixed feedstream passed through a bubbler to produce 100% RH at RT.

Oxidation of CO and H₂ by O₂ proceeds by reactions 1 and 2, respectively:

CO+1/2O₂=CO₂ 1

H₂+1/2O₂=H₂O 2

CO oxidation activity (or H₂ oxidation activity) is determined as the percent CO (H₂) conversion at a given temperature and the temperature at which 50% conversion is achieved (T₅₀). COPROX selectivity is determined according to the mol percentage of O₂ consumed by CO oxidation relative to the mol percentage of O₂ consumed by H₂ oxidation (Eq. 1):

$$selectivity ( \% ) = 100 \times \frac{mol {CO}_{2} produced}{2 \times mol {O}_{2} consumed} \qquad ( Eq . 1 )$$

With a 1:1 mol ratio of CO to O₂ in the reaction feed, the minimum selectivity according to (Eq. 1) is 50%.

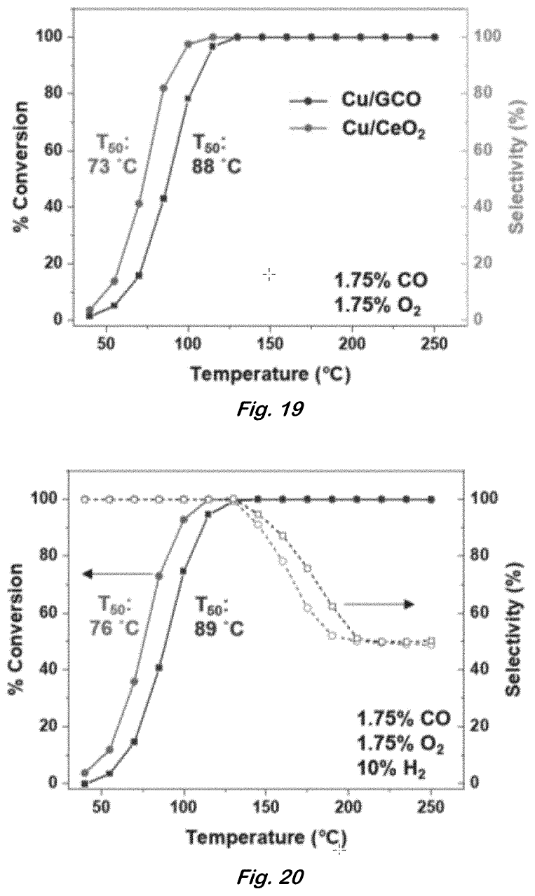

FIGS. 19-21 summarize the activity and selectivity of Cu/CeO₂ and Cu/GCO aerogels in different feedstreams. Both catalysts are highly active towards CO oxidation without H₂ or H₂O added and achieve 100% CO conversion by ˜125° C. (FIG. 19). The temperature at which Cu/CeO₂ and Cu/GCO convert 50% of CO (T₅₀) is ˜73° C. and ˜88° C., respectively. The lower activity of Cu/GCO may be related to the persistence of oxygen vacancies at the surface: the MvK mechanism requires lattice oxygen to be extracted, but at Gd-induced oxygen vacancy sites the oxide cannot be further reduced. The calcined CeO₂ and GCO aerogels show minimal CO oxidation activity without photodeposited Cu NPs. The concentration of CO₂ produced closely matches CO consumption during trial runs and no other products are detected, implying a product selectivity toward CO₂ of effectively 100% under dry, H₂-free conditions.

With H₂ in the feedstream (FIG. 20), only minor shifts in CO oxidation activity for Cu/CeO₂ and Cu/GCO were observed. Detectable consumption of H₂ does not occur until >130° C., therefore, selectivity below this temperature is 100%. Above this temperature, H₂ consumption increases with increasing temperature until all the residual oxygen is consumed and selectivity hits a minimum of 50%. For both catalysts, the disparate temperatures at which CO and H₂ oxidation occur create an operating window where effectively 100% of CO is oxidized with >95% selectivity. Catalytic testing was also performed with sufficient O₂ present to consume all CO and H₂ and it was found that even with excess O₂ in the feedstream (20%), H₂ consumption is negligible until 145° C. The Tso for H₂ oxidation with 20% O₂ in the feedstream is 176 and 185° C. for Cu/CeO₂ and Cu/GCO aerogels, respectively, ˜100° C. higher than the T₅₀ for CO oxidation.

The remarkable selectivity is attributed to the nature of active sites facilitated by the morphology characteristic of Cu NPs well-dispersed in the ceria network. Expressing the supporting oxides as aerogels maximizes intimate contact between the supported metal NP and the networked nanoparticulate oxide, as indicated for Cu/CeO₂ and Cu/GCO by the lack of evidence for discrete Cu phases in TEM or XRD. Because CO oxidation is preferred at Cu//oxide interfacial sites (Gamarra et al., J. Am. Chem. Soc. 2007, 129, 12064-12065), the aerogel morphology is a synthetically opportune method to maximize those sites. Although Cu/GCO has a higher T₅₀ than Cu/CeO₂, it demonstrates higher selectivity (FIG. 20), perhaps a result of greater Cu//oxide intimacy facilitated by the smaller crystallites of the GCO network.

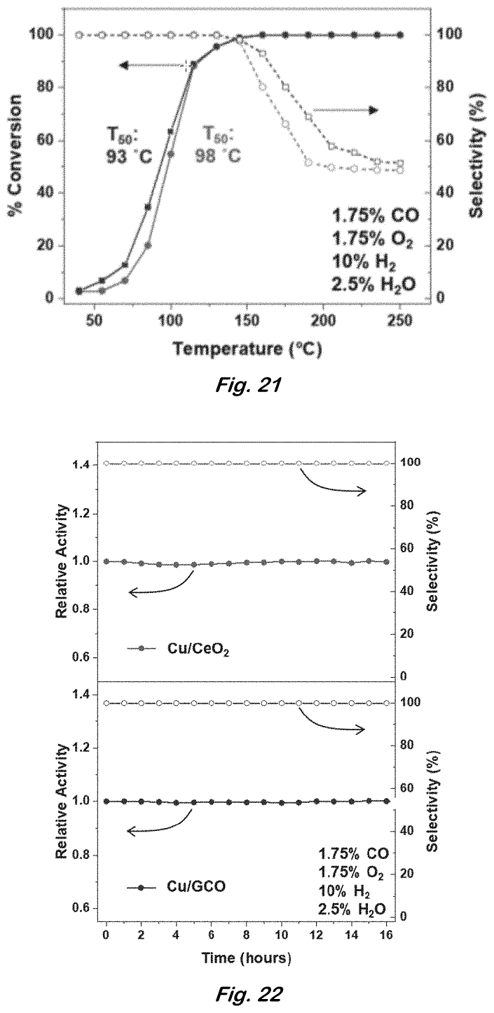

The addition of H₂O to the reaction stream significantly lowers the CO oxidation activity of Cu/CeO₂ and pushes its T₅₀ from 76 to 98° C. (FIG. 21). In contrast, the activity of Cu/GCO is only mildly impacted by water vapor, with T₅₀ shifting from 89 to 93° C. The loss of activity in the presence of water vapor is common for transition-metal COPROX catalysts, but it is notable that with the aerogel-expressed catalysts, an operational temperature window is observed that couples high activity (T₅₀) to selectivity (see Eq. (1)). These architected COPROX catalysts demonstrate >95% CO conversion and >95% selectivity toward CO₂ under humid conditions (Tiscornia et al., Int. J. Hydrogen Energy 2020, 45, 6636-6650; Cabello et al., Top. Catal. 2019, 62, 931-940; Avgouropoulos et al., Chem. Eng. J. 2006, 124, 41-45; Park et al., J. Power Sources 2004, 132, 18-28; Reis et al., Catal. Today 2020, 344, 124-128; Xu et al., Int. J. Hydrogen Energy 2019, 44, 4156-4166).

The observation that architected Cu/GCO experiences less deactivation in the presence of H₂O than Cu/CeO₂ holds important implications in catalyst design. Oxidizing CO in the presence of water is thought to be transport limited, where the rate-limiting step of Cu⁺-carbonyl formation is blocked by adsorbed molecular water at CuOx interfacial sites (Gamarra et al., J. Catal. 2009, 263, 189-195). Depletion of hydroxyls may be another contributing factor, as the relative abundance of hydroxyls dictate whether CO oxidation proceeds through the more favorable bicarbonate pathway or the less favorable carbonate pathway. Abundant hydroxyls promote the formation of bicarbonates in preference to carbonates, with the former species benefitting CO oxidation (Davó-Quiñonero et al., ACS Catal. 2016, 6, 1723-1731). The higher surface area of Cu/GCO more effectively distributes adsorbed water through the structure, while the higher concentration of oxygen vacancies ensures formation of abundant hydroxyl groups (Kundakovic et al., Surf Sci. 2000, 457, 51-62; Yang et al., J. Phys. Chem. C 2010, 114, 14891-14899), both of which mitigate blocking of active sites.

To further confirm this resilience in the presence of water, the long-term activity and selectivity of the architected catalysts at 100° C. was monitored (FIG. 22). Neither Cu/CeO₂ nor Cu/GCO aerogel show a loss in activity; after 16 h, activity is within 1% of its initial value, well within the margin of error. Selectivity is maintained at 100% throughout the run. This stability is remarkable among non-noble metal catalysts: Cu catalysts are known to experience continuous deactivation under humidified feedstreams (Gongalves et al., ACS Appl. Mater. Interfaces 2015, 7, 7987-7994). Other transition metals commonly used for COPROX, such as Mn and Co, are similarly unstable in the presence of H₂O (Basu et al., ChemCatChem 2020, 12, 3753-3768).

As a reference for the aerogel-based supporting oxides, 5 wt. % Cu was photodeposited over commercial CeO₂ nanopowder (Cu/CeO₂—COM) and this non-networked catalyst was evaluated under dry and humidified feedstreams. Cu/CeO₂—COM shows a more severe activity loss in the presence of water than either Cu/CeO₂ or Cu/GCO aerogels, with the T₅₀ shifting from 101 to 140° C. Upon returning the sample to a dry feedstream and repeating the light-off curve, activity is lower than its initial activity, indicating that humidity has caused irreversible deactivation.

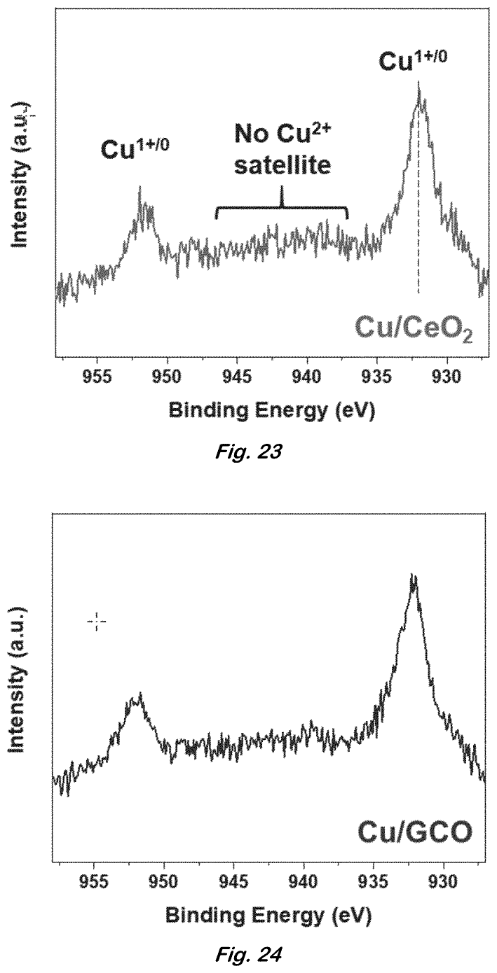

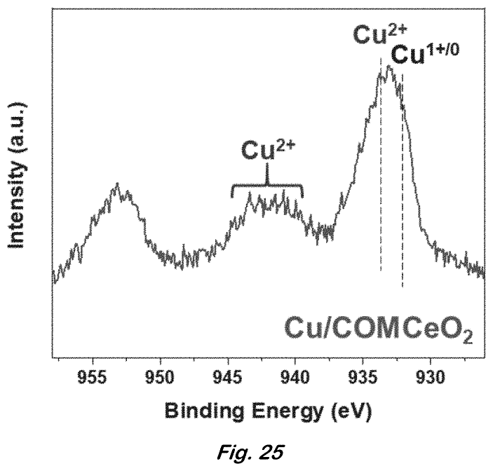

Ex situ XPS analysis of recovered catalysts (FIGS. 23-25) reveals stark differences between aerogel and non-aerogel supports in terms of Cu speciation. Copper in Cu/CeO₂ and Cu/GCO aerogels persists as low-valent (0/1+), with minimal trace of the characteristic Cu²⁺ satellite. The recovered Cu/CeO₂—COM catalyst displays prominent satellite peaks and broadening of the primary peaks with contributions from higher binding energy Cu²⁺. The poor water resilience, instability, and significant Cu²⁺ formation in Cu/CeO₂—COM highlight the importance of the aerogel structure for stabilization of active low-valent Cu.

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. A method comprising:
providing a catalyst comprising:
a ceria aerogel; and
copper nanoparticles;
flowing a source gas comprising hydrogen, carbon monoxide, and water vapor from an inlet into contact with the catalyst to produce a product gas; and
flowing the product gas to an outlet;
wherein the concentration of carbon monoxide in the product gas is no more than 50% of the concentration of carbon monoxide in the source gas; and
wherein the concentration of hydrogen in the product gas is no less than 90% of the concentration of hydrogen in the source gas.

2. The method of claim 1, wherein the concentration of carbon monoxide in the product gas is no more than 10% of the concentration of carbon monoxide in the source gas.

3. The method of claim 1, wherein the catalyst comprises up to 10 wt. % of the copper nanoparticles.

4. The method of claim 1, wherein the ceria is doped with up to 20 mol % gadolinium.

5. The method of claim 1, further comprising:
heating the catalyst to an elevated temperature.

6. The method of claim 5, wherein the elevated temperature is no more than 200° C.

7. The method of claim 1, wherein the outlet directs the product gas into a hydrogen storage vessel.

8. The method of claim 1, wherein the outlet directs the product gas into a fuel cell reaction chamber.

9. An apparatus comprising:
a catalyst chamber;
a catalyst within the catalyst chamber comprising:
a ceria aerogel; and
copper nanoparticles;
an inlet for flowing a source gas comprising hydrogen, carbon monoxide, and water vapor in contact with the catalyst;
an outlet for flowing a product gas from the catalyst chamber.

10. The apparatus of claim 9, wherein the catalyst comprises up to 10 wt. % of the copper nanoparticles.

11. The apparatus of claim 9, wherein the ceria is doped with up to 20 mol % gadolinium.

12. The apparatus of claim 9, further comprising:
a heater that can heat the catalyst.

13. The apparatus of claim 9, further comprising:
a hydrogen storage vessel coupled to the outlet.

14. The apparatus of claim 9, further comprising:
a fuel cell having a reaction chamber coupled to the outlet.
